(19) United States
(12) Patent Application Publication
(10) Pub. No.: US 2010/0106651 A1
(43) Pub. Date: Apr. 29, 2010

(54) REAL ESTATE TRANSACTION MANAGEMENT SYSTEM

(76) Inventor: Drew L. Tate, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/604,122

(22) Filed: Oct. 22, 2009

Related U.S. Application Data
(60) Provisional application No. 61/108,087, filed on Oct. 24, 2008.

(51) Int. Cl. G06Q 50/00; G06Q 30/00; G06Q 20/00; G06Q 10/00; G06Q 40/00; G06F 17/30; G06F 3/048

(52) U.S. Cl. 705/80; 705/26; 705/7; 705/35; 707/609; 715/771; 707/E17.005

(57) ABSTRACT

An automated system and method for managing real estate transactions includes a processing unit and a memory that may store program instructions for execution by the processing unit. The program instructions implement a real estate transaction management system that may include a contract negotiation module that may be configured to iteratively maintain, within the memory, one or more electronic versions of a real estate contract. The contract negotiation module may also provide access to each version of the contract by each party to the contract and may generate a new version of the contract in response to at least one of the parties editing, electronically initialing and electronically signing one or more times on any page of a given version of the contract. The contract negotiation module may further notify at least some parties in response to each new version being submitted.

This application claims the benefit of U.S. Provisional Application No. 61/108,087, filed Oct. 24, 2008.

### BACKGROUND OF THE INVENTION

1. Field of the Invention

This invention relates to a real estate transaction management and, more particularly, to an interactive system for managing all aspects of a real estate transaction.

2. Description of the Related Art

From initiation to the closing of a deal, real estate transactions typically require a number of negotiations, forms, and interactions between a number of key groups of participants that perform services that affect the transaction either directly or indirectly. Accordingly, a conventional way for a real estate agent representing a seller may list a given property either in a Multiple Listing Service (MLS), online, or in a newspaper or other printed media. A prospective buyer that is interested in placing a contract on the property may contact the seller's agent directly or through a buyer's agent. Depending on the number of concessions that need to be worked out, there may be a large number of offers and counter offers made, typically via a facsimile machine. In many cases, after several faxes back and forth the faxes begin to get unreadable.

In addition, agents typically have to manually (e.g., via telephone or other interactive mechanism) contact the various participants to either initiate the transaction or to monitor its progress throughout the transaction process. For example, title companies, mortgage lenders, surveyors, and the like, all need to be involved and to perform specific tasks, and some tasks are dependent upon other tasks, such that one task cannot proceed until one or more of the other tasks are completed. In some cases, there may be disconnects in communication between parties, or difficulty in obtaining contact information for key people and services in the process flow, thus slowing down the entire transaction process. Accordingly, there may be any number of disconnects that can and do hold up real estate transactions performed in a conventional manner.

### SUMMARY

Various embodiments of a system and method for managing real estate transactions are disclosed. In one embodiment, the system includes a processing unit and a memory that may be configured to store program instructions for execution by the processing unit. The program instructions implement a real estate transaction management system that may include a contract negotiation module that may be configured to iteratively maintain, within the memory, one or more electronic versions of a real estate contract. The contract negotiation module may also provide access to each version of the real estate contract by each party to the real estate contract. The contract negotiation module may also generate a new version of the real estate contract in response to at least one of the parties editing, electronically initialing and electronically signing one or more times on any page of a given version of the real estate contract. The contract negotiation module may further notify at least some parties to the real estate contract in response to each new version of the real estate contract being submitted by a given party to the real estate contract.

In one particular implementation, the real estate transaction management system may also include a transaction manager module that may be configured to initiate and track each phase a real estate transaction process that includes electronic negotiation of the real estate contract.

In another implementation, the real estate transaction management system may also include a user interface that may be configured to provide and display an interactive graphical representation of one or more process steps of the real estate transaction process in a time-based format. In addition, one or more of the process steps may provide user selectable access to additional associated information dependent upon, for example, a user access class of the particular user.

In yet another specific implementation, the real estate transaction management system may further include a value add interface module that may maintain a preferred vendor database, and may automatically provide selected vendor information to the transaction manager module for presentation to a user during selected phases of the real estate transaction process.

### BRIEF DESCRIPTION OF THE DRAWINGS

FIG. 1 is a block diagram of a computer system including a real estate transaction management system.

FIG. 2 is a diagram depicting more detailed aspects of an embodiment of the real estate transaction management system of FIG. 1.

FIG. 3 is a diagram of one embodiment of an exemplary transaction manager module of FIG. 2.

FIG. 4 is an illustration of an exemplary embodiment of a graphic user interface on a display.

FIG. 5 is a diagram of one embodiment of the contract negotiator module of FIG. 2.

FIG. 6 is a diagram of one embodiment of the value add interface module as shown in FIG. 2.

FIG. 7 is a diagram of one embodiment of the membership module as shown in

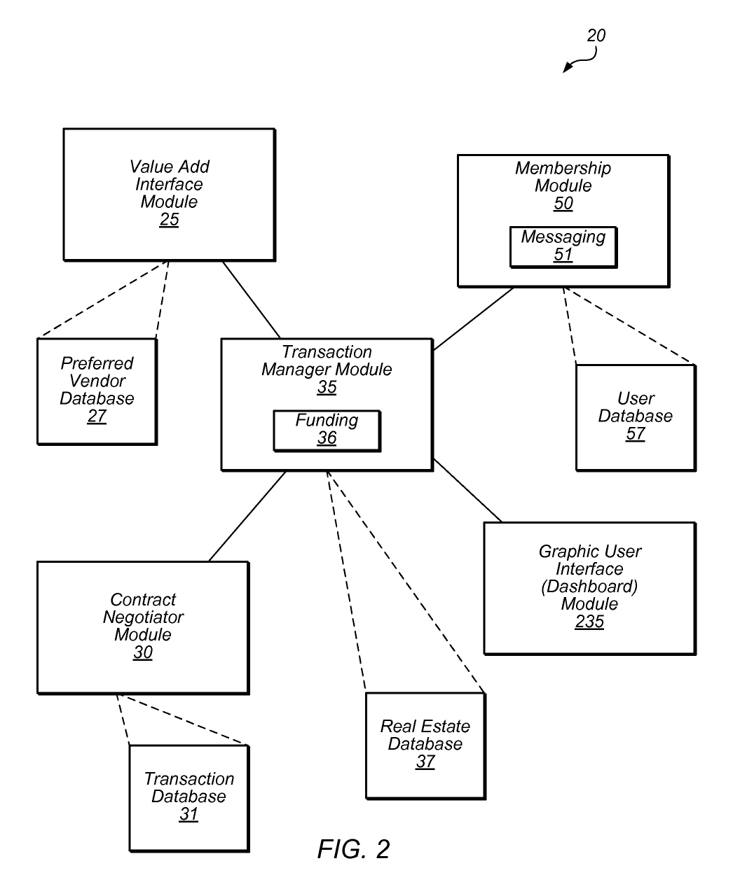

FIG. 2.

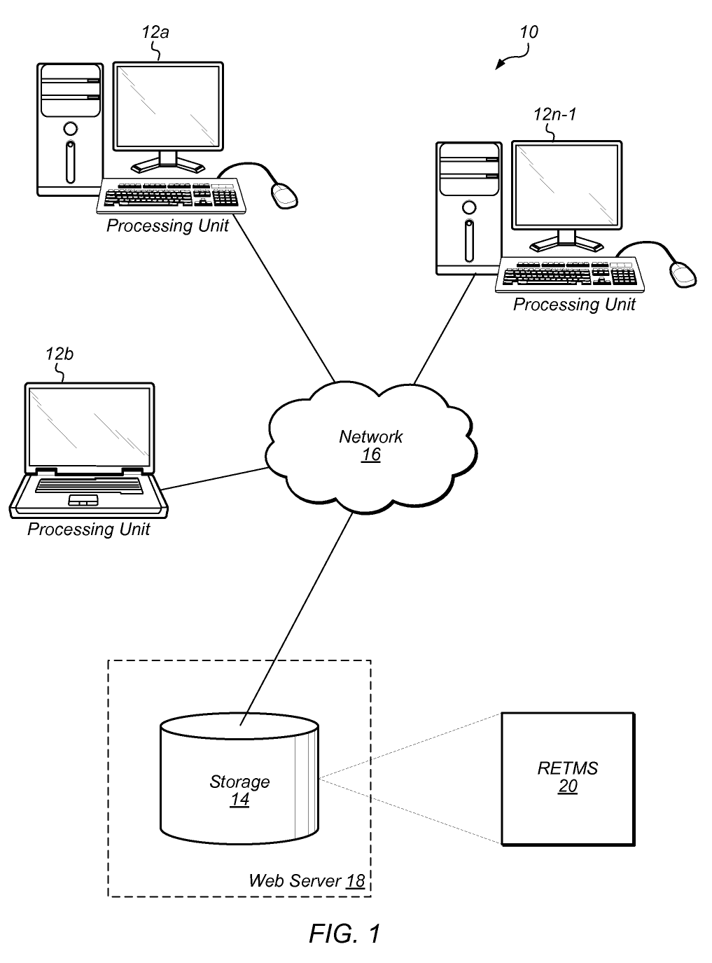

FIG. 8 is a flow diagram describing the operational flow of the real estate transaction management system of FIG. 1 through FIG. 7.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. It is noted that the word “may” is used throughout this application in a permissive sense (i.e., having the potential to, being able to), not a mandatory sense (i.e., must).

### DETAILED DESCRIPTION

Turning now to FIG. 1, a block diagram of one embodiment of a computer system including a real estate transaction management system is shown. The computer system 10 includes a number of processing units, designated processing units 12a through 12n−1, where n may be any number. The processing units 12a, 12b, and 12n−1 are coupled through a network 16 to a storage 14. As shown, storage 14 includes a real estate transaction management system (RETMS) 20 stored thereon. As indicated by the dashed lines storage 14 may be part of a web server system 18 or other hosting solution. It is noted that a component having a reference number and a letter may be referred to by the number only where appropriate. It is also noted that any of the connections between the processing units 12 and the network 16 may be wireline or wireless connections in various embodiments. It is further noted that in an alternative embodiment, the entire RETMS 20 may be implemented on a single processing unit that may be accessed via wireline or wireless connections, as desired.

In one embodiment, storage 14 may be representative of a storage system that is part of a network-based storage system, or as mentioned above, storage 14 may be part of a web hosting server storage solution or the like. In the network-based storage system, the network 16 may include one or more storage area network (SAN) servers (not shown).

In one embodiment, each of the processing units 12 may be representative of a personal computer or a workstation. In addition, although processing unit 12b is shown as a laptop computer, any given processing unit 12 may be a mobile device, such as a mobile phone, personal digital assistant, or the like. As shown, any of processing units 12 may include one or more processors, input/output (I/O) such as monitors, keyboards, mice, and the like, and memory. For example, the memory may include volatile memory storage such as dynamic random access memory (DRAM), and permanent storage that may include hard disk drives, and removable non-volatile storage such as compact disk (CD) memory (all not shown). In addition, each of processing units 12 may include removable storage media drive units and or universal serial bus (USB) ports that may accommodate removable flash memory storage units and the like. Accordingly, during operation, a user may operate a processing unit 12 and access, or download either an instance or a portion of the RETMS 20 on storage 14 to the local memory storage, for execution by the one or more processors.

More particularly, in one embodiment, the RETMS 20 may be a web-based application in which all transactions are processed on the web server and all the information may be stored on storage 14. Alternatively, the RETMS 20 may reside on storage 14, and a user may download the necessary portions to run the transaction application locally, while some portions such as database information may be stored on the storage 14.

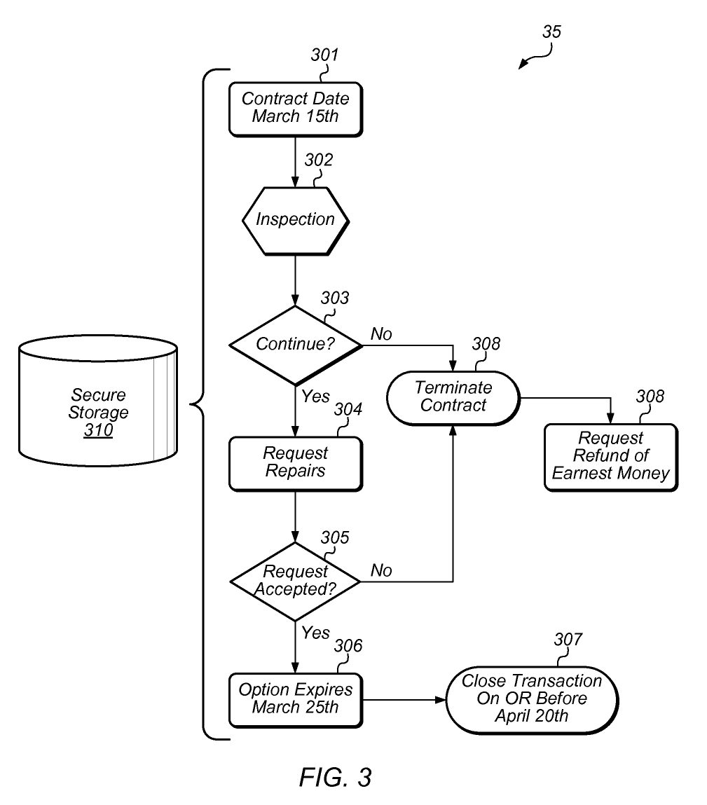

Referring to FIG. 2, a diagram depicting more detailed aspects of an embodiment of the real estate transaction management system of FIG. 1 is shown. RETMS 20 includes a transaction manager module 35 that is coupled to a graphic user interface (GUI) module 235, which is sometimes referred to as the user “dashboard.” The transaction manager module 35 may also access a real estate database 37. In addition, the RETMS 20 includes a contract negotiator module 30 that is coupled to the transaction manager module 35, and may access a transaction database 31. The RETMS 20 also includes a membership module 50 that is coupled to the transaction manager module 35. The membership module 50 may access a user database 57. Further, the RETMS 20 includes a value add interface module 25 that is coupled to the transaction manager module 35. As shown, the value add module 25 may access a preferred vendor database 27. FIG. 3 through FIG. 7 illustrate in more detail, various aspects of each of the modules shown in FIG. 2.

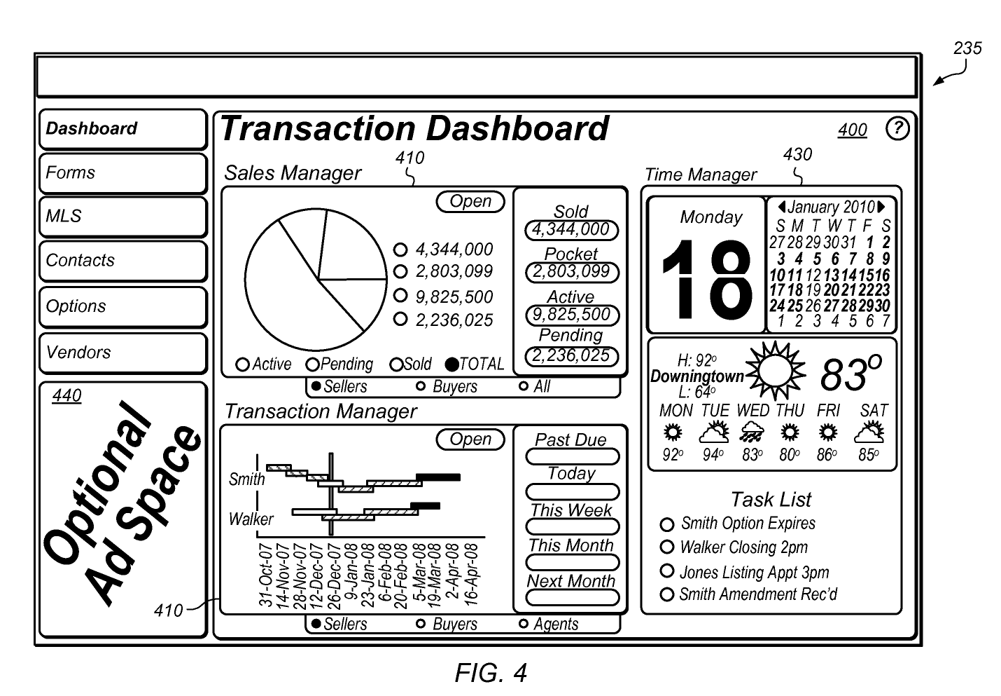

In one embodiment, the transaction manager module 35 may be configured to launch the GUI 235 which may display for a user various aspects of one or more real estate transactions. For example, the transaction manager module 35 may tie together all aspects of the transaction and present the transaction process steps to a user in one or more ways. In one embodiment, the transaction manager module 35 may, in conjunction with the GUI 235, generate Gantt charts, pie charts, timelines and/or other time based representations that illustrate the process steps in chronological order and the status of each of the steps. In addition, the process steps may be “clickable” such that should a user desire to drill down into a particular process step, they may simply click on that step to check the details of the step. For example, if a title company is in the process of performing a title search, they may have uncovered a problem and are accordingly behind schedule. A user might simply click on the title search step, which may open a dialogue box or “pop up” that accesses the title company database for more information, or the dialogue box may include the contact information for the title company. A similar approach may be used for each step of the real estate transaction. FIG. 4 illustrates an exemplary GUI 235 presented as a transaction dashboard on a user display.

Referring to FIG. 4, the GUI 235 depicts a transaction dashboard 400 which includes a number of management functions. For example, as shown, the sales manager 410 depicts a pie chart including sales information with selectable pie chart views (e.g., Active, Pending, Sold, and Total). The transaction manager function 420 includes a Gantt chart depicting a timetable of events for two clients (e.g., Smith and Walker). The transaction manager 420 also includes selectable views (e.g., Sellers, Buyers, and Agents). In addition, the time manager 430 includes a calendar view, as well as local weather information, a task list that shows various upcoming events from the Gantt chart. On the left side of the transaction dashboard 400 are selections for various user selectable subviews (e.g., Forms, MLS, Contacts, Options). Lastly, the transaction dashboard 400 includes optional advertisement space 440, which may include advertisements, such as targeted or general ads that may be presented to a user dependent upon such parameters as the phase of real estate transaction process, the access class of the user, among others.

In one embodiment, a user may “drill down” or selectively obtain various additional information within the various management windows. For example, by clicking the open button icon in either the sales manager 410 or the transaction manager 420, the transaction dashboard 400 may open a new window that includes more information about that particular manager. In addition, in the Gantt chart, a user may slide the vertical bar to change the data listed in the task list on the right.

It is noted that the transaction dashboard 400 shown in FIG. 4 is merely an exemplary dashboard shown for discussion purposes. In other embodiments, the transaction dashboard may include other managers, have different fields, and may have different selections as desired.

FIG. 3 is a diagram of one embodiment of an exemplary transaction manager module 35. Referring to FIG. 3, a secure storage 310 may store the real estate database 37. In one embodiment, secure storage 310 may be representative of storage 14 of FIG. 1, although in other embodiments, secure storage 310 may be a different storage. In addition, the transaction manager module 35 may access or call all other databases and modules in the RETMS 20. As described above, the transaction manager module 35 may tie together and manage all the process steps involved in initiating and completing a real estate transaction, and in displaying these steps in an interactive way using GUI 235.

More particularly, the transaction manager module 35 may include one or more default or standard process flows that include predetermined process steps. As described above, the process flows may include the steps necessary to initiate, manage, and complete a real estate transaction. For example, in FIG. 3, an exemplary flow is shown. In block 301a contract having a date of March 15 may be initiated, the next step in this exemplary flow is an inspection needs to be performed (block 302). After the inspection, a prospective buyer may decide whether or not to continue based on the inspection results (block 303). If the buyer wishes to continue, they may or may not request that repairs be performed (block 304). If the requested repairs are accepted (block 305), then the option to purchase may expire on March 25^{th}, for example (block 306). The next step in the flow may be closing the transaction on or before April 20^{th} (block 307).

Referring back to block 305, if the repair request is denied, the contract may be terminated (block 308), and a request for a refund or the earnest money may be made (block 309).

In various embodiments, the steps represented in the transaction manager 35 may be customized by individual users such as Realtor users. For example, a brokerage may require its agents to follow a custom transaction flow in order to increase the probability that agents follow specific “best practices” or meet “legal requirements.” Accordingly, a Realtor user may add or remove steps from a “default” transaction flow that may be built into the system. As described above, multiple views of the transaction flow may be utilized such as Gantt charts, flow charts, pie charts, or timeline charts, for example. Realtor users may dictate which transaction flow steps are visible in a particular user's view of the GUI. Typically, a client's view may have a less comprehensive set of steps than the Realtor user's set of steps. However, certain important dates such as the contract execution date, the option period date, and the closing date, for example, may typically be visible to all parties involved in the transaction.

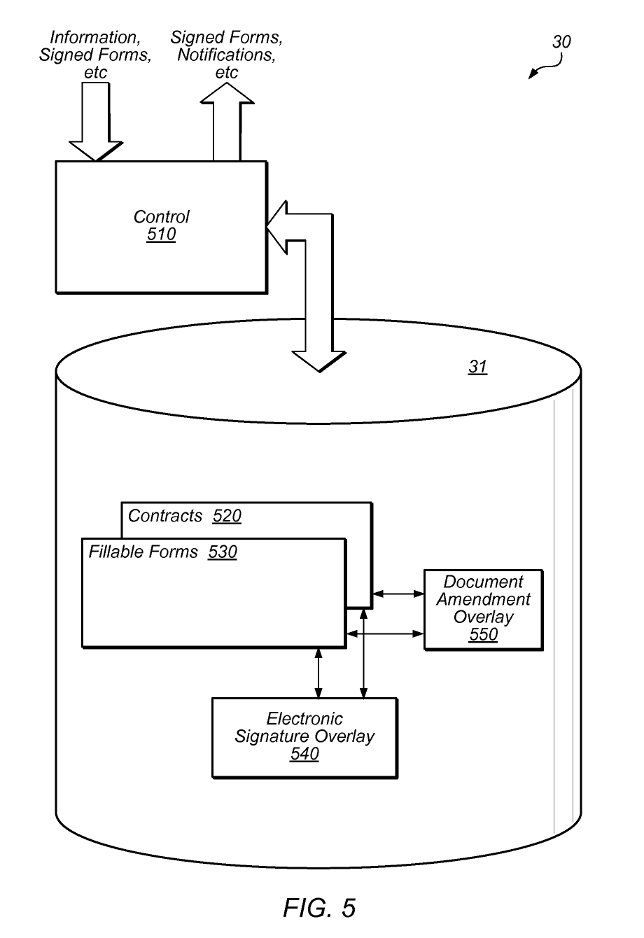

Referring back to FIG. 2, a user such as a Realtor user, for example, may initiate a transaction by placing a contract on a property. In one embodiment, this contract negotiation may be handled within the framework of the contract negotiator module 30, which may save the most current as well as any number of previous versions of a contract document. In FIG. 5, a diagram of one embodiment of a contract negotiator module 30 is shown. In one embodiment, the contract negotiator module 30 may include a control module 510 that is coupled to the transaction database 31. In one embodiment, the transaction database may be stored within storage 14.

The control module 510 may be configured to handle such tasks as maintaining and presenting a number of forms used during a real estate transaction. For example, the control module 510 may provide fill-able blank forms, such as contract 520, and other forms 530 (e.g., listing agreements, disclosure documents, contract amendment forms, attorney, mortgage or title company documents, and so on). Some of these forms may be auto-filling forms that fill or populate automatically with information stored in the user database 57, or the real estate database 37, for example. In addition, the contract negotiator module 30 may handle communication between parties when, for example, the contract is being negotiated, each time a party enters a concession or bid, the other party may be notified, and either provided an acceptable electronically signed or initialed copy of the revised contract or notified that the signed revised contract may be downloaded. This may occur through many iterations of the negotiation process, during which each page of the various forms, and/or an entire document (signed and otherwise) may be electronically signed, electronically initialed, edited (negotiated) and resigned after each change. The various forms and versions may be dated and stored within the transaction database 31. When the contract is agreed upon by all parties, the final draft may be electronically signed by all parties, the signed copy may be sent to all parties, and printed for physical signing if necessary. It is noted that an electronic signature may be implemented in a variety of accepted ways according to the laws that govern electronic signatures in commerce.

In one embodiment, the control module 510 may generate new versions of a given contract 520 by using the electronic signature overlay 540 in combination with the document amendment overlay 550 and any stored version of contract 520 or fillable form 530. More particularly, in one embodiment, any form or contract may serve as the base layer of a new version. When a user makes changes to the base document, the changes may be recorded or stored on the amendment layer 550, and the electronic signatures and initials are stored on the signature layer 540. These layers may be merged by the control module 510 into the new version when the edited and/or signed document is submitted by the user. Thus, in one embodiment, the base document may be a blank contract 520, blank fillable form 530, or a previously stored version of either. In addition, a form such as a scanned document may be saved to the transaction database 31 and also serve as a base document.

Accordingly, the contract negotiator module 30 may be configured to maintain various in-progress versions of the requisite forms associated with the contract negotiation, as well as coordinate, through the use of the transaction manager module 35, and the membership module 50 the notification of the various parties to the negotiation. In addition, the contract negotiator module 30 may be configured to automatically launch additional forms that are associated with the present contract based on either the default system settings or custom settings discussed above. Thus, the back and forth nature of contract negotiation may be handled by the contract negotiator module 30 from contract initiation all the way to completion and a fully executed contract.

Referring again to FIG. 2, the membership module 50 may provide an interface to the user database 57. The user database 57 may store all information associated with all users. For example, there may be a number of different classes of users, and they may be arranged in a hierarchical ordering according to their access privileges. In one embodiment, there may be Realtor users, buyers, sellers, vendors, and many sub-classes of those users. Accordingly, each class or sub-class may have different access privileges and corresponding access to certain data. For example, certain classes of vendors (e.g., mortgage lenders) may have access to financial information of a buyer user so that mortgage offers may be made during the real estate transaction processing. However, other vendor classes may not have access to that same information. The membership module 50, in conjunction with the GUI 235, may use the information in the user database 57 to handle login and authentication of all users. The membership module may also handle verification of user agreement to terms-of-use (including legal requirements for use of electronic signatures).

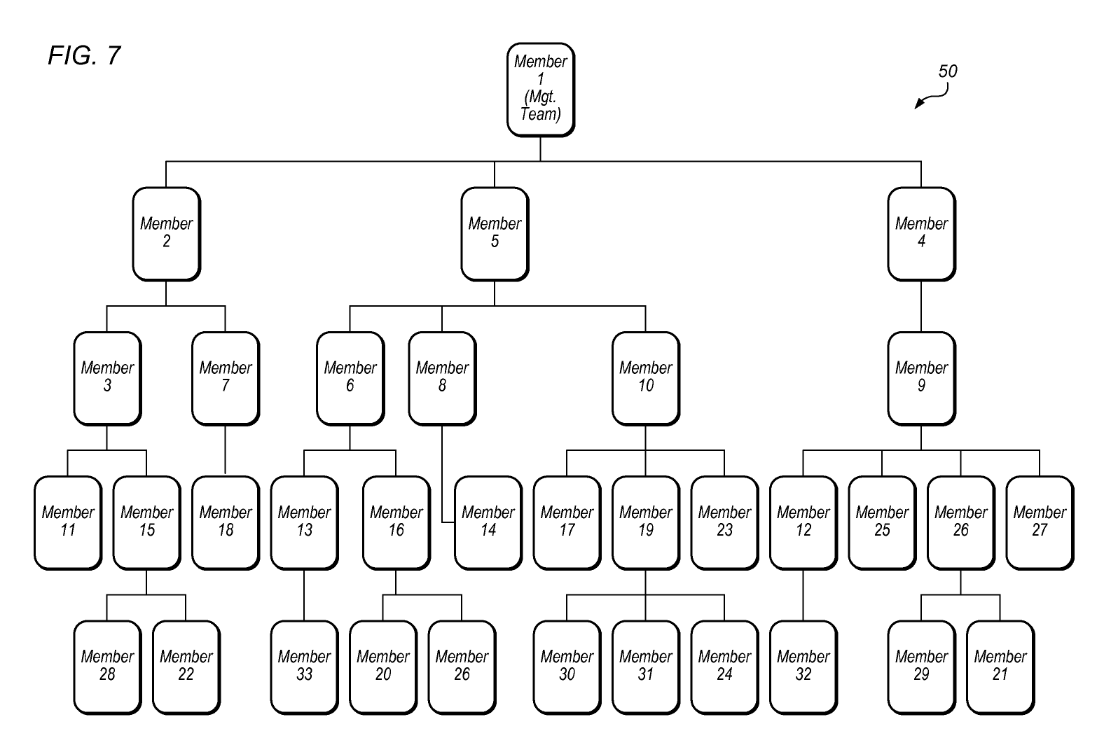

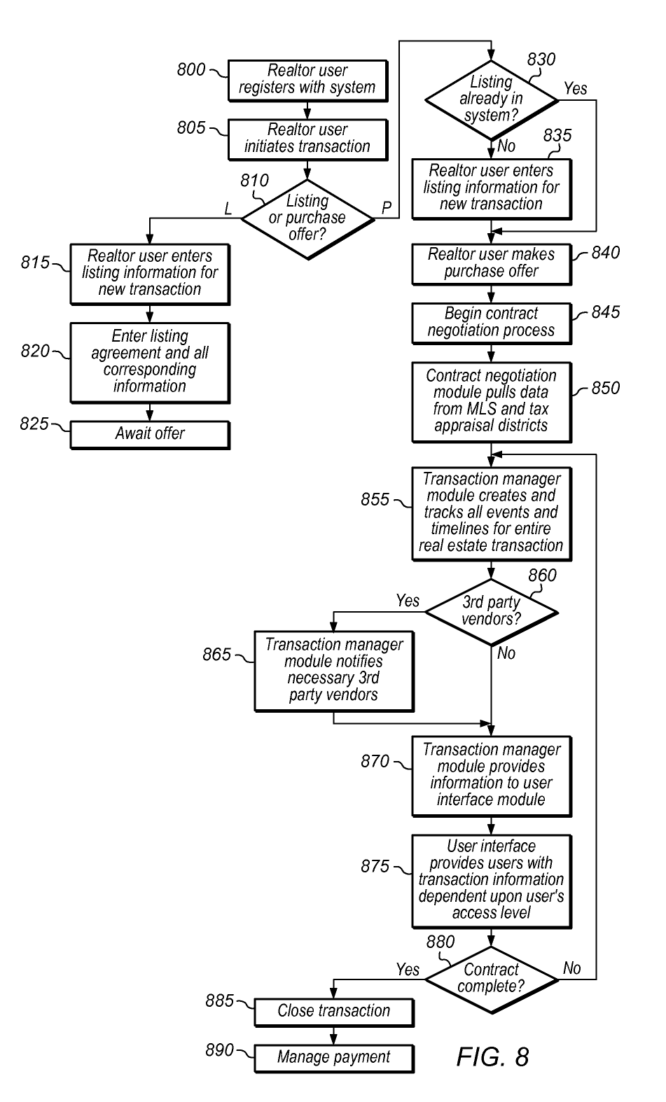

The membership module 50 may also keep track of member users and their rank according to financial compensation within the organization. Thus, the membership module 50 may track commissions and payments to various member users. FIG. 7 is a diagram of an exemplary membership module 50 structure.

In addition, the membership module 50 may further include a messaging interface 51 that may interface to one or more email and/or other electronic messaging system platforms. In one embodiment, contacts and member information may be imported and exported in a usable format. The messaging interface 51 may allow the contract negotiator module 30 and/or the transaction manager module 35 to send messages to individuals and distribution lists via email, text message, or other electronic medium. Lastly, the messaging interface 51 may allow the contract negotiator module 30 and/or the transaction manager module 35 to send electronic packages of documents to users and third parties that are not users at any time during or after the negotiation process. For example, the messaging interface 51 may be configured to import contact information associated with non-user contacts and to send packages including title documents, mortgage documents, etc. to the third parties and to users in the user database.

Referring back to FIG. 2, the value add interface module 25 module may be configured to interface and present various vendors into the transaction process by feeding information to the transaction manager module 35. Accordingly, the preferred vendor database 27 may maintain information about a number of vendors that provide services to the real estate transaction process or to homeowners in general. A value add member may be any vendor that may be involved in a real estate transaction, as well as any of the much wider range of merchants and service providers who's goods and services might be of interest to a home seller or buyer. For example, primary value add members may include title companies, mortgage lenders, home warranty companies, survey companies, home inspection companies, utilities (e.g., water, gas, power, phone, cable, Internet Service Providers, alarm system monitoring, etc.), and so on. Secondary value add members may include painters, repair contractors, landscape designers, pool contractors, home repair stores, furniture stores, and so on. It is noted the above list is only a sample of the types of value add members and is not exhaustive.

The value add interface module 25 may interactively present these preferred vendors to a user during selected points in the transaction process. For example, at selected places in the transaction timeline, pop up dialogue boxes may automatically present questions to the user regarding their vendor choices, and also provide suggested vendors. In addition, the value add interface module 25 may allow the buyer or seller to select a vendor to bid on a purchase, or simply allow a vendor to offer a discount coupon to encourage a home buyer or seller to visit their store or web site. Realtors and their brokerages may be able to add or delete vendors from the list as desired. Additionally, vendors may be allowed to purchase or bid for special positioning in a vendor selection list, sidebar advertising space, or other product positioning opportunities. In addition, some vendors may pay referral fees when a client selects their services based upon a referral from the Realtor. Accordingly, any such referral fees may be tracked by the transaction manager module 35 in conjunction with the membership module 50.

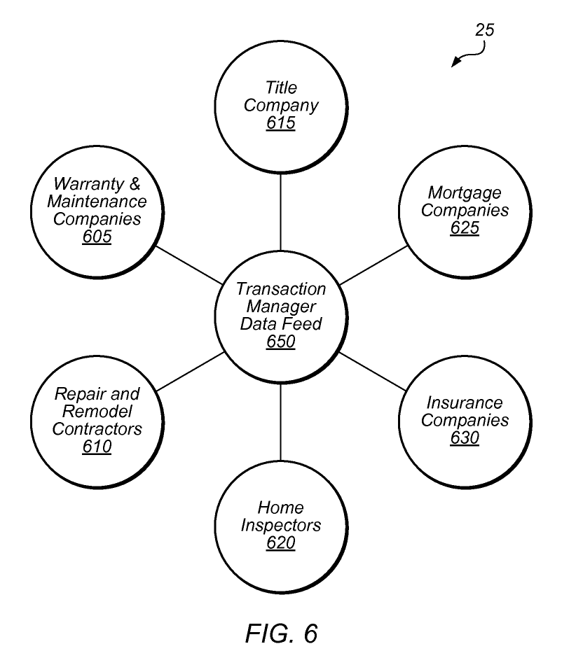

Referring to FIG. 6, an exemplary value add interface module 25 is shown. In one embodiment, the transaction manager module 35 may provide the information from the value add interface module 25 via the GUI 235. As mentioned above, various contractors and other service providers (“vendors”) may be stored in the preferred vendor database 27. These preferred vendors may be placed in the database and presented at appropriate times to clients contingent upon a variety of factors such as ranking in their respective industries, location, fees paid, quality of service rankings, and the like.

Turning to FIG. 8, a flow diagram describing the operational flow of one embodiment of the real estate transaction management system of FIG. 1 through FIG. 7 is shown. Referring collectively to FIG. 1 through FIG. 8, and beginning in block 800 of FIG. 8, a Realtor user registers with the RETMS 20 and enters all necessary user information. The Realtor user may initiate a transaction with the RETMS 20 (block 805). The transaction may be, for example, a listing transaction or a purchase offer transaction for a listing already in the system (block 810).

If the transaction is a listing transaction, the Realtor user enters the listing information into the system. For example, the multiple listing service (MLS) number may be entered, along with any other pertinent listing information (block 815). In one embodiment, the transaction manager module 35 may automatically populate the database entry for the listing by retrieving information from the MLS, tax records or other accessible government or public domain databases, for example. The Realtor user may then enter the listing agreement and any other corresponding information (block 820). In various embodiments, the information may include all information needed to populate the appropriate real estate contract form used in a particular jurisdiction (e.g., state) to make an offer on the property. For example, in Texas, the Texas Real Estate Commission (T.R.E.C), One to Four Family Residential Contract (Resale) 20-8 form may be used for a resale of an existing home). The transaction manager module 35 may also present a questionnaire to assist in automated selection of the proper real estate forms, disclosures, reports and addenda for the property being sold. Once all listing information is entered and stored, the transaction manager 35 may assign a link (e.g., unique URL) to this property. The URL may be distributed to other users who will use the link to access the sales contract. At this point, the Realtor user may log off or perform other tasks, and the listing awaits an offer to be entered (block 825).

Referring back to block 810, if the transaction is a purchase offer on a listing and the listing is not in the RETMS 20 (block 830), the Realtor user may enter the listing and populate the real estate database as described in block 815 (block 835). If the listing has already been entered, the Realtor user may initiate the purchase offer (block 840).

The Realtor user may initiate a contract negotiation process using the GUI 235 to pull up a contract (block 845). In one embodiment, the contract negotiator module 30 may pull data from the MLS and tax appraisal districts to populate or partially populate the contract form (block 850), although in other embodiments the Realtor user may pull up a blank form and use information provided by the contract negotiator module 30 to manually populate the contract form.

The transaction manager module 35, in conjunction with the GUI 235, may create and track all process steps and events using timelines and charts for the entire real estate transaction as well as maintaining a date and time-stamped archive of all steps and events (block 855). In addition, the transaction manager module 35 may provide real-time monitoring, updating and notification to various users of the events and process steps. Further, the transaction manager module 35 may provide, using the GUI 235, various user options for upcoming process steps. For example, if 3^{rd} party vendors are needed (block 860), the transaction manager module 35 may notify the necessary vendors using email, instant messaging, and the like (block 865). The vendor information may be provided to the user interface module or GUI 235 (block 870). The user interface module 235 may present the information to each user dependent upon an access level that a given user has been granted (block 875). More particularly, each user may only access information to which they have been granted access as described above. If the contract is not complete, in one embodiment, the contract negotiator module 30 loops through the various phases of the transaction (block 880). When all process steps have been completed, and the contract is signed electronically by all necessary parties, the contract may be transmitted to the title company and to any appropriate parties as determined by the permissions set in the membership module 50.

In one embodiment, the transaction manager module 35 may facilitate payments of option fees, earnest money, and any other necessary monetary transfers required to execute the contract or “place the contract in escrow.” For example, in one embodiment, the transaction manager module 35 may include a funding interface 36 to facilitate electronic funds transfer from one of many funding sources. In addition, since option money and earnest money have a deadline to be delivered (e.g., two days in some cases), the transaction manager module 35 may also verify electronic and manual funds transfer, and then provide funds delivery status information. In another embodiment, the transaction manager module 35 may extract specific date and/or timeline data from the contract and provide a visualization of “action items” to the users via the GUI 235, as well as provide suggestions based on a set of “industry best practices” programmed into the transaction manager module 35. For example, a query may include the question, “Would you like to contact a home inspector to inspect the property?” Once the proper steps have been taken (and assuming the transaction is not terminated through the issuance of the appropriate contract termination form), the transaction may be closed (block 885). The transaction manager module 35 may in one embodiment, provide details to the membership module 50, which may in turn manage the proper payment of all parties.

Thus, as described above, the transaction manager module 35 may play a key role in providing a clear customizable process flow of a real estate transaction that can be viewed by each type of user. Additionally, the contract negotiator module 30 may provide a mechanism to negotiate a real estate contract electronically, including verifiable, and legally binding signatures, throughout the sometimes many iterations of the negotiation process. Further, the flow that is available to each type of user may be customized for that type of user such that only information that a given user is authorized to see, and/or that the given user needs to see may be viewed. By its nature, the transaction manager module 35 effectively “walks” any user through the transaction flow and provides various pieces of information at each step in the flow.

It is noted that although the embodiments described above include various modules that include specific functionality, it is contemplated that in other embodiments some functionality described as part of one module above may be part of a different module.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A system comprising:
a processing unit; and
a memory coupled to the processing unit and configured to store program instructions for execution by the processing unit;
wherein the program instructions implement a real estate transaction management system including:
a contract negotiation module configured to iteratively maintain, in the memory, one or more versions of a real estate contract, each version including one or more pages;
wherein the contract negotiation module configured to provide access to each version of the real estate contract by each party of a plurality of parties to the real estate contract;
wherein the contract negotiation module is further configured to generate a new version of the real estate contract in response to at least one of the parties editing, electronically initialing and electronically signing one or more times on any page of a given version of the real estate contract; and
wherein the contract negotiation module is further configured to notify at least some of the parties in response to each new version of the real estate contract being submitted by a given party.

2. The system as recited in claim 1, wherein the real estate transaction management system includes a transaction manager module configured to initiate and track each phase of a plurality of phases of a real estate transaction process that includes electronic negotiation of the real estate contract.

3. The system as recited in claim 2, wherein the transaction manager module is configured to automatically and without user intervention populate and maintain a real estate database by locating and downloading information associated with one or more real estate listings that have been added to the real estate transaction management system.

4. The system as recited in claim 2, wherein the real estate transaction management system includes a user interface configured to provide an interactive graphical representation of one or more process steps of the real estate transaction process in a time-based format, and wherein one or more of the process steps provide user selectable access to additional associated information.

5. The system as recited in claim 2, wherein the real estate transaction management system includes a membership module coupled to the transaction manager module and configured to maintain a user database including a hierarchical user structure, wherein the hierarchical user structure includes one or more user access classes.

6. The system as recited in claim 2, wherein the real estate transaction management system includes a value add interface module coupled to the transaction manager module and configured to maintain a vendor database, and to automatically provide selected vendor information to the transaction manager module for presentation to a user during selected phases of the real estate transaction process.

7. The system as recited in claim 2, wherein the transaction manager module includes a funding interface configured to facilitate an electronic transfer of funds from a selected funding source to a receiver of the funds.

8. The system as recited in claim 7, wherein the transaction manager module is further configured to ensure delivery of the funds from the selected funding source to the receiver within a predetermined amount of time.

9. The system as recited in claim 1, wherein each new version of the real estate contract includes any previous electronic signatures and initials submitted in a previous version of the real estate contract, and a new electronic signature and a new electronic initial does not invalidate the previous electronic signatures and electronic initials on items in the real estate contract that have not been edited.

10. A method comprising:
operating a real estate transaction management system on one or more computer systems including:
iteratively maintaining in a storage one or more versions of a real estate contract, each version including one or more pages;
providing access to each version of the real estate contract by each party of a plurality of parties to the real estate contract;
generating a new version of the real estate contract in response to at least one of the parties editing, electronically initialing and electronically signing one or more times on any page of a given version of the real estate contract; and
notifying at least some of the parties in response to each new version of the real estate contract being submitted by a given party.

11. The method as recited in claim 10, further comprising the real estate transaction management system initiating and tracking each phase of a plurality of phases of a real estate transaction process that includes electronic negotiation of the real estate contract.

12. The method as recited in claim 11, further comprising the real estate transaction management system automatically and without user intervention populating and maintaining a real estate database by locating and downloading information associated with one or more real estate listings that have been added to the real estate transaction management system.

13. The method as recited in claim 11, further comprising the real estate transaction management system providing an interactive graphical a user interface including a representation of one or more process steps of the real estate transaction process in a time-based format, and wherein one or more of the process steps provide user selectable access to additional associated information.

14. The method as recited in claim 11, further comprising the real estate transaction management system maintaining a user database including a hierarchical user structure, wherein the hierarchical user structure includes one or more user access classes.

15. The method as recited in claim 11, further comprising the real estate transaction management system maintaining a vendor database, and automatically providing selected vendor information for presentation to a user during selected phases of the real estate transaction process.

16. The method as recited in claim 11, further comprising the real estate transaction management system facilitating an electronic transfer of funds from a selected funding source to a receiver of the funds.

17. A computer readable storage medium including program instructions executable by a processor to:
iteratively maintain in a storage one or more versions of a real estate contract each version including one or more pages;
provide access to each version of the real estate contract by each party of a plurality of parties to the real estate contract;
generate a new version of the real estate contract in response to at least one of the parties editing, electronically initialing and electronically signing one or more times on any page of a given version of the real estate contract; and
notify at least some of the parties in response to each new version of the real estate contract being submitted by a given party.

18. The computer readable storage medium as recited in claim 17, wherein the program instructions are further executable to initiate and track each phase of a plurality of phases of a real estate transaction process that includes electronic negotiation of the real estate contract.

19. The computer readable storage medium as recited in claim 18, wherein the program instructions are further executable to automatically and without user intervention populate and maintain a real estate database by locating and downloading information associated with one or more real estate listings that have been added to the real estate transaction management system.

20. The computer readable storage medium as recited in claim 18, wherein the program instructions are further executable to provide an interactive graphical a user interface including a graphical representation of one or more process steps of the real estate transaction process in a time-based format, and wherein one or more of the process steps provide user selectable access to additional associated information.
